(19) United States
(12) Patent Application Publication
(10) Pub. No.: US 2013/0297061 A1
(43) Pub. Date: Nov. 7, 2013

(54) METHOD AND COMPUTER-AIDED DESIGN SYSTEM OF MANUFACTURING AN OPTICAL SYSTEM

(71) Applicants: Kuen-Yu Tsai, Taipei (TW); Sheng-Yung Chen, Taipei (TW); Shin-Chuan Chen, Taipei (TW)

(72) Inventors: Kuen-Yu Tsai, Taipei (TW); Sheng-Yung Chen, Taipei (TW); Shin-Chuan Chen, Taipei (TW)

(73) Assignee: NATIONAL TAIWAN UNIVERSITY, Taipei (TW)

(21) Appl. No.: 13/463,685

(22) Filed: May 3, 2012

(51) Int. Cl. G06F 17/50

(52) U.S. Cl. 700/103

(57) ABSTRACT

A method of manufacturing an optical system is described. The method comprises designing at least one performance specification for an optical system, defining at least one fabrication parameter of a component of the optical system, fabricating the component according to the at least one fabrication parameter, obtaining at least one fabrication error of the component during the fabrication process, predicting at least one operation performance of the optical system by simulating with the at least one fabrication error, determining whether the operation performance corresponds with the at least one performance specification, and repeating fabricating the component by using at least one new parameter if the operation performance does not correspond with the at least one performance specification.

### FIELD OF THE EMBODIMENTS

The present disclosure relates to a system and a method of manufacturing an optical system with manufacturability analysis for an optical system.

### BACKGROUND

Microlithography, a process for transferring desired patterning information to a wafer, is one of the most critical processes in integrated circuit fabrication. Currently, the mainstream technology for integrated circuit fabrication is through optical projection lithography with 193-nm deep ultraviolet (UV) lasers and water immersion techniques, and its resolution, mainly limited by wave diffraction, has been pushed to 45-nm in half-pitch. Associated mask complexity and costs have become almost prohibitive due to the strong resolution enhancement techniques required to compensate for the diffraction effects. It is possible to achieve 32-nm half-pitch resolution by employing double-patterning techniques, but this process complexity increases significantly. Several next-generation lithography techniques are being investigated for the 22-nm half-pitch node and beyond.

However, fabrication errors of the subsystem or the components of the optical system for lithography process always exist regardless of the fabrication method used and cannot be totally eliminated. These errors may or may not significantly influence the performance of the optical system. Traditionally, a typical optical system is assembled and tested directly after the subsystems are fabricated. If the performance of the optical system is not within specifications, the whole fabrication process will be repeated until all the performances of the optical system are satisfactory. It is not an efficient procedure and the yield can degrade significantly because subsystems with unacceptable fabrication errors cannot be identified before the assembly step.

Therefore, there is a need for an improved system that can analyze the fabrication errors that may result in each step of fabrication process to ensure a higher manufacturing yield.

### SUMMARY

The present application describes a system and method of manufacturing an optical system. In one embodiment, a method of manufacturing an optical system is described. The method comprises defining at least one performance specification for an optical system; defining at least one fabrication parameter of a component of the optical system; fabricating the component according to the at least one fabrication parameter; obtaining at least one fabrication error of the component during the fabrication process if a measured parameter of the fabricated component deviates from the at least one fabrication parameter; predicting at least one operation performance value of the optical system by simulating fabrication with the at least one fabrication error; determining whether the at least one operation performance value corresponds with the at least one performance specification; and repeating fabricating the component by using at least one new parameter if the at least one operation performance value does not correspond with at least one the performance specification.

In other embodiments, a computer-aided design system of manufacturing an optical system is described. The computer-aided design system comprises an input unit, a memory unit, a processing unit, a transmitting unit, and a simulation module. The input unit, the memory unit, the transmitting unit, and the simulation module are connected to the processing unit. The input unit is configured to receive at least one performance specification and at least one fabrication parameter of a component of the optical system. The processing unit is configured to store the at least one performance specification and the at least one fabrication parameter in the memory unit. The transmitting unit is configured to transmit the at least one fabrication parameter to a to manufactory (factory) and receive at least one fabrication error of the component during the fabrication process from the manufactory. The simulation module is configured to simulate with the at least one fabrication error to predict an operation performance of the optical system. The processing unit is further configured to determine whether the operation performance corresponds with the at least one performance specification, and output an indicating signal to the manufactory via the transmitting unit.

At least one advantage of the systems and methods of manufacturing an optical system described herein is the ability to predict the operation performance according to the at least one fabrication error by simulation before the optical system is assembled and tested, which could significantly reduce the cost and time required for manufacturing the optical system.

The foregoing is a summary and shall not be construed to limit the scope of the claims. The operations and devices disclosed herein may be implemented in a number of ways, and such changes and modifications may be made without departing from this disclosure and its broader aspects. Other aspects, inventive features, and advantages of the disclosure, as defined solely by the claims, are described in the non-limiting detailed description set forth below.

### BRIEF DESCRIPTION OF THE DRAWINGS

FIG. 1 is a simplified diagram illustrating a design house and a manufactory for operating a manufacturability analysis for an optical system in accordance with an embodiment of the present disclosure;

FIG. 2 is a flowchart of exemplary method elements of manufacturing an optical system in accordance with an embodiment of the present disclosure;

FIG. 3 is a schematic diagram illustrating a computer-aided design system of manufacturing an optical system in accordance with an embodiment of the present disclosure;

FIG. 4 is a flowchart of exemplary method elements of manufacturing an optical system in accordance with an embodiment of the present disclosure; and

FIG. 5 is a flowchart of exemplary method elements of manufacturing an optical system in accordance with an embodiment of the present disclosure.

### DETAILED DESCRIPTION OF EMBODIMENTS

The present application describes systems and methods of manufacturing an optical system. The system and the method of manufacturing an optical system employ post-fabrication optical system performance simulation before the optical system is assembled and tested. By simulating the optical system performance with geometry parameters measured from fabricated components, whether at least one fabrication error or an imperfect component is acceptable could be early determined and predicted before assembly and testing. The method may be performed by software or in combination with software and hardware via a single computer or via multiple computers that interact with one another.

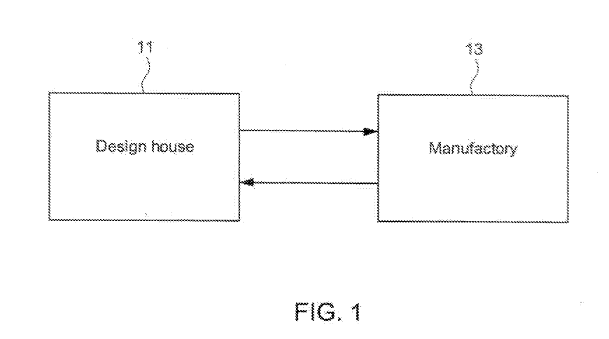

FIG. 1 is a simplified diagram illustrating a design house and a manufactory for operating a manufacturability analysis for an optical system in accordance with an embodiment of the present disclosure.

Broadly speaking, a method of manufacturability analysis for the optical system may mainly be performed in a design house 11 or in a manufactory 13. The optical system may be a wave optical system or a particle optical system. The design house 11 provides at least one fabrication parameter of a subsystem or a component of the optical system to the manufactory 13. The manufactory 13 utilizes a plurality of equipment to fabricate many of the duplicated subsystems or components of the optical system according to the at least one fabrication parameter. During the fabrication process, some fabrication errors may exist.

The fabrication errors may be detected or measured by a measuring apparatus at the manufactory 13, then the measuring apparatus may transmit the at least one fabrication error data corresponding to the at least one fabrication error to the design house 11. A computer-aided design system at the design house 11 may be triggered to analyze the at least one fabrication error data and simulate an operation performance of the optical system according to the at least one fabrication error. Moreover, the computer-aided design system could determine whether the operation performance corresponds with the at least one performance specification. If the operation performance does not correspond with the at least one performance specification, the computer-aided design system may transmit a signal to indicate to the manufactory 13 to repeat fabricating the subsystems or the components of the optical system by at least one new fabrication parameter until the operation performance is within the at least one performance specification.

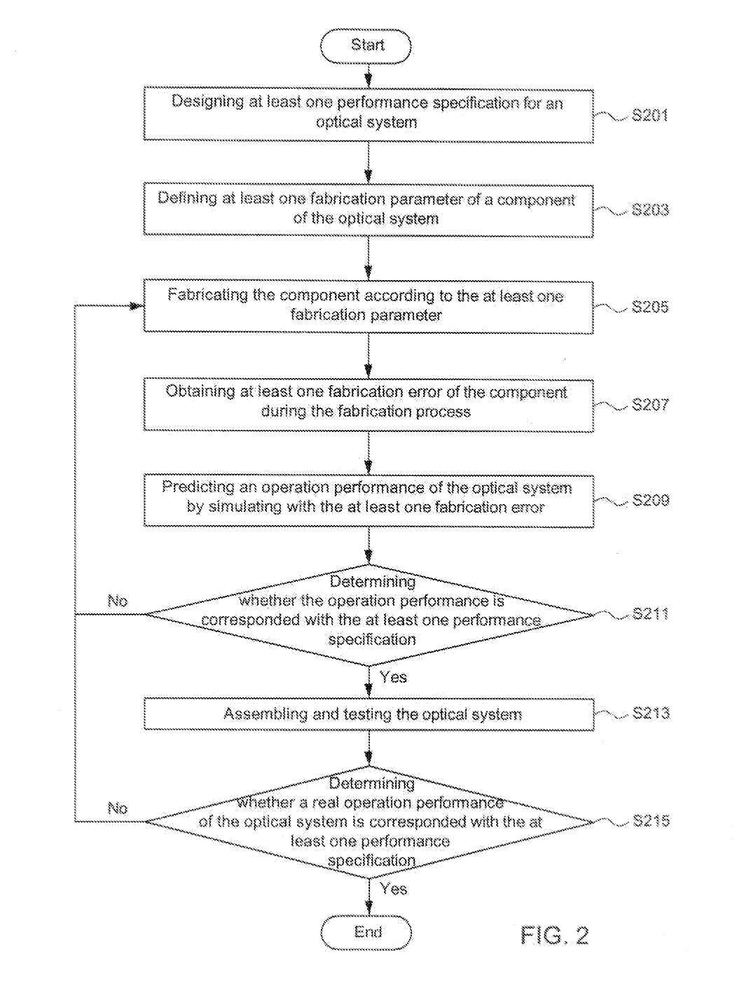

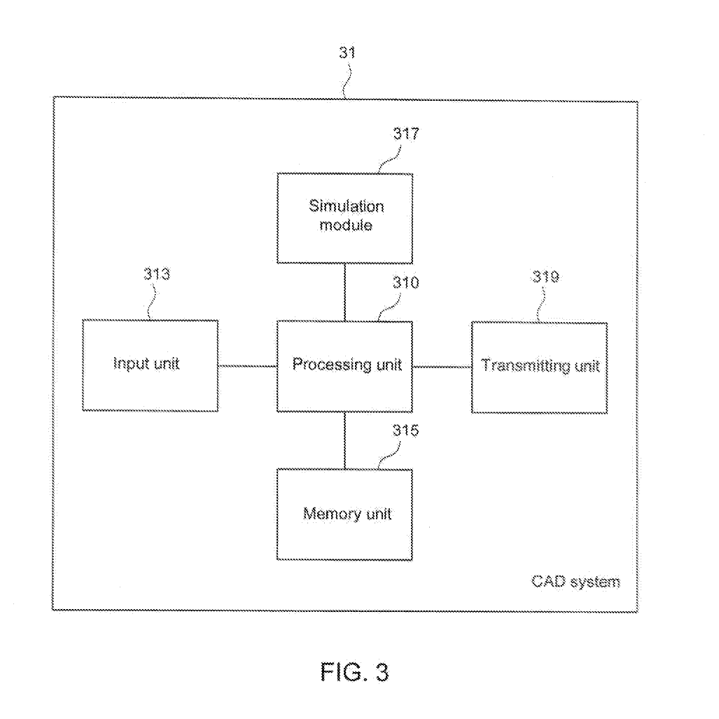

In conjunction with FIG. 1, FIG. 2 is a flowchart of exemplary method elements of manufacturing an optical system in accordance with an embodiment of the present disclosure, and FIG. 3 is a schematic diagram illustrated a computer-aided design system of manufacturing an optical system in accordance with an embodiment of the present disclosure. In one embodiment, an optical system is desired for operating microlithography in the manufactory 13, and a designer in the design house 11 may design the optical system via a computer-aided design (CAD) system 31.

In one embodiment and as shown in FIG. 3, the CAD system 31 may comprise a processing unit 310, an input unit 313, a memory unit 315, a simulation module 317, and a transmitting unit 319. The input unit 313 is connected to the processing unit 310 and is configured to receive the at least one performance specification and the at least one fabrication parameter of the subsystems or the components of the optical system. The memory unit 315 is connected to the processing unit 310 and configured to store the at least one performance specification and the at least one fabrication parameter from the processing unit 310. The simulation module 317 is connected to the processing unit 310 and configured to simulate with the at least one fabrication error to predict the operation performance of the optical system. The transmitting unit 319 is connected to the processing unit 310 and configured to transmit the at least one fabrication parameter to the manufactory 13 and receive the at least one fabrication error of the subsystems or the components of the optical system during the fabrication process from the manufactory 13. The processing unit 310 is configured to determine whether the operation corresponds with the at least one performance specification and transmit the indicating signal to the manufactory 13 via the transmitting unit 319.

Referring now to FIG. 2, at step 201, a designer the design house defines at least one performance specification for the desired optical system. In one embodiment, the designer may input the performance specification to the CAD system 31 via the input unit 313. The processing unit 310 may receive the at least one performance specification and store it in the memory unit 315. At step 203, the designer defines at least one fabrication parameter of the subsystem or the component of the optical system. In one embodiment, the designer may define the at least one fabrication parameter by a simulation technique or a mathematic operation via the CAD system 31. For example, the mathematic operation may be an interpolation algorithm operating with an empirical value.

After step 203, the designer may operate the CAD system 31 to transmit the at least one fabrication parameter to the manufactory 13. In one embodiment, processing unit 310 may receive the at least one fabrication parameter and output it via the transmitting unit 319. At step 205, the manufactory 13 may fabricate the subsystem or the component of the optical system according to the at least one fabrication parameter. After fabrication, there may or may not be at least one fabrication error if a measured value of the fabricated component deviates from the at least one fabrication parameter. At step 207, the measuring apparatus at the manufactory 13 may measure or sensor at least one fabrication error resulting from the fabrication process and output the at least one fabrication error to the design house 11.

In one embodiment, the design house 11 may actively require that the at least one fabrication error be communicated to the CAD system 31 after the subsystem or the component is fabricated. The CAD system may obtain the at least one fabrication error via the transmitting unit 319.

At step 209, the CAD system 31 may predict an operation performance value of the optical system by simulating the current fabrication error via the simulation module 317. At step 211, the processing unit 310 may determine whether the operation performance value corresponds with the at least one performance specification. If the operation performance value does not correspond with the at least one performance specification and the fabricated component deviates from the at least one fabrication parameter, the processing unit 310 may output an indicating signal to the manufactory 13 via the transmitting unit 319. The indicating signal may indicate to the manufactory 13 to repeat step 205 by at least one new fabrication parameter. The loop between step 205 and step 211 would then be replayed until the processing unit 310 determines that the at least one operation performance value corresponds with the at least one performance specification.

If the processing unit 310 determines that the at least one operation performance value corresponds with the at least one performance specification, the processing unit 310 may output another indicating signal to the manufactory 13 to assemble and test the optical system as shown at step 213. In one embodiment, a testing apparatus at the manufactory 13 may obtain a real operation performance of the assembled optical system. In one embodiment, the testing apparatus may determine whether the real operation performance of the optical system corresponds with the at least one performance specification. If the real operation performance does not correspond with the at least one performance specification, the manufactory 13 will repeat fabricating the subsystem or the component of the optical system (i.e., at step 205) by at least one new fabrication parameter until the real operation performance corresponds with the at least one performance specification.

In an alternative embodiment, the testing apparatus may transmit the real operation performance to the CAD system 31, and the processing unit 310 may determine whether the real operation performance of the optical system corresponds with the at least one performance specification. If the real operation performance does not correspond with the at least one performance specification, the processing unit 310 will output another indicating signal to the manufactory 13. Then the manufactory 13 will repeat fabrication of the subsystem or the component of the optical system (i.e., at step 205) by at least one new fabrication parameter until the real operation performance corresponds with the at least one performance specification.

Accordingly, the design house 11 may provide important information to the manufactory 13 for improving the yield during the fabrication process. The fabrication errors and imperfect components could be screened by rigorous simulation, but the present disclosure may significantly reduce the cost and time consumed for the optical system manufacture.

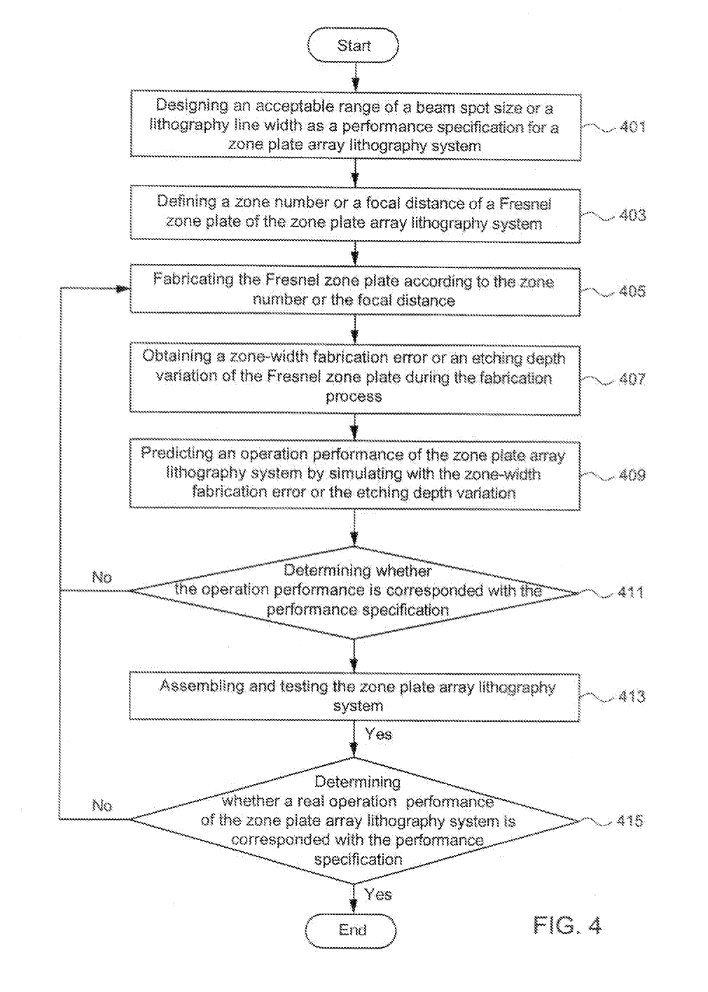

In conjunction with FIG. 1 and FIG. 3, FIG. 4 is a flowchart of exemplary method elements for manufacturing a zone plate array lithography (ZPAL) system in accordance with an embodiment of the disclosure.

The ZPAL system leads to the need to develop a maskless zone plate array (ZPA) pattern generator where a collimated beam from the light source is focused by a Fresnel zone plate (FZP) array to form an array of fine spots on a substrate coated with a layer of photoresist. Each individual beam may be turned on and off by micromechanical shutters, while the substrate may be scanned under the ZPA to write circuit patterns. Maskless FZP lithography has been demonstrated in the deep UV (DUV), UV, and X-ray regimes.

FZPs are classical diffractive-optical elements serving as flat lenses. The FZPs have been used in nanoscale applications such as soft-X-ray microscopy with a sub-15-nm spatial resolution. In order to achieve ideal focusing performance and minimize beam-to-beam variation in parallel writing applications, fabrication of the FZPs has to be very precise.

Since the FZP fabrication is a complicated process with many steps, each of the fabrication errors resulting from each step needs to be analyzed. This is especially important for the ZPAL systems because a large number of the FZPs need to be integrated into the ZPAs and assembled with other subsystems for illumination, beam alignment, beam blanking, and substrate movement.

As shown in FIG. 4, at step 401, a designer at the design house designs an acceptable range of a beam spot size or a lithography line width as a performance specification for a ZPAL system. In one embodiment, the designer defines at least one performance specification to the CAD system 31 via the input unit 313. The processing unit 310 may receive the one or more performance specification and store it in the memory unit 315. At step 403, the designer defines a zone number or a focal distance of the FZPs of the ZPAL system as at least one fabrication parameter. In one embodiment, the designer may define the at least one fabrication parameter by simulation techniques or a mathematic operation via the CAD system 31.

After step 403, the designer may operate the CAD system 31 to transmit the fabrication parameters from the design house 11 to the manufactory 13. In one embodiment, processing unit 310 may receive the fabrication parameter and output it via the transmitting unit 319. At step 405, the manufactory 13 may fabricate the FZPs of the ZPAL system according to the at least one fabrication parameter. After fabrication, a measured value of the fabricated component may deviate from at least one fabrication error during the fabrication process according to the fabrication parameter. In one embodiment, the fabrication error, such as a zone-width variation or an etching depth variation, may be measured in the fabrication process. At step 407, a measuring apparatus at the manufactory 13 may measure or sensor the fabrication error that occurred during the fabrication process and output the fabrication error to the design house 11. In one embodiment, the design house 11 may actively require the fabrication error via the CAD system 31 after the FZPs are fabricated. The CAD system 31 may obtain the fabrication error via the transmitting unit 319.

At step 409, the CAD system 31 may predict the effects of the fabrication error on a focusing performance of the FZP as an at least one operation performance value of the ZPAL system by simulating with the current fabrication error via the simulation module 317. In one embodiment, the simulation module 317 may employ Fraunhofer and Fresnel approximations based on scalar formulas for the analysis of electromagnetic fields passing through the FZPs. The at least one operation performance value may comprise the beam spot size or the lithography line width of the FZP. In one embodiment, the simulation results show that the FZP designed with a larger number of zones has a sharper intensity distribution, its peak intensity is also more sensitive to the radius deviation due to the fabrication errors. The full-width at half-maximum (FWHM) may increase slightly with the deviation of the inner and outer radii of each zone of the FZPs (A). The relative beam spot size, defined as the intensity width at a fix percentage of the maximum intensity, is insensitive to the radius deviation A.

At step 411, the processing unit 310 may determine whether the at least one operation performance value corresponds with the performance specification. If the operation performance does not correspond and the fabricated component deviates from the performance specification, the processing unit 310 may output an indicating signal to the manufactory 13 via the transmitting unit 319. The indicating signal may indicate to the manufactory 13 to repeat fabricating the FZPs as shown at step 405 by at least one new fabrication parameter. The loop between step 405 and step 411 may be replayed until the processing unit 310 determines the current operation performance value corresponds with the performance specifications.

If the processing unit 310 determines that the at least one operation performance value corresponds with the performance specification, the processing unit 310 may output another indicating signal to the manufactory 13 to assemble and test the ZPAL system as shown at step 413. In one embodiment, a testing apparatus at the manufactory 13 may obtain a real operation performance of the assembled ZPAL system such as the beam spot size or the lithography line width of the FZP. In one embodiment, the testing apparatus may determine whether the real operation performance value of the ZPAL system corresponds with the performance specification. If the real operation performance value does not correspond with the performance specification, the manufactory 13 may repeat fabricating the FZP of the ZPAL system (i.e., at step 405) until the real operation performance corresponds with the performance specification.

In an alternative embodiment, the testing apparatus may transmit the real operation performance to the CAD system 31, and the processing unit 310 could determine whether the real operation performance of the ZPAL system corresponds with the performance specification. If the real operation performance does not correspond with the performance specification, the processing unit 310 will output another indicating signal to the manufactory 13. Then the manufactory 13 will repeat fabricating the FZP of the ZPAL system (i.e., at step 405) by at least one new fabrication parameter until the current real operation performance corresponds with the performance specification.

Accordingly, a new ZPAL design-to-manufacturing flow that takes fabrication errors into account before the assembly step has been proposed. The manufacturability analysis in terms of fabrication inaccuracy can provided useful information to improve the design and fabrication of high-quality ZPAL system. Therefore, the system and the method of manufacturability analysis for the ZPAL system could significantly improve the fabrication yield of ZPAL systems since the fabrication errors and imperfect FZPs can be effectively screened before the ZPAL system is assembled.

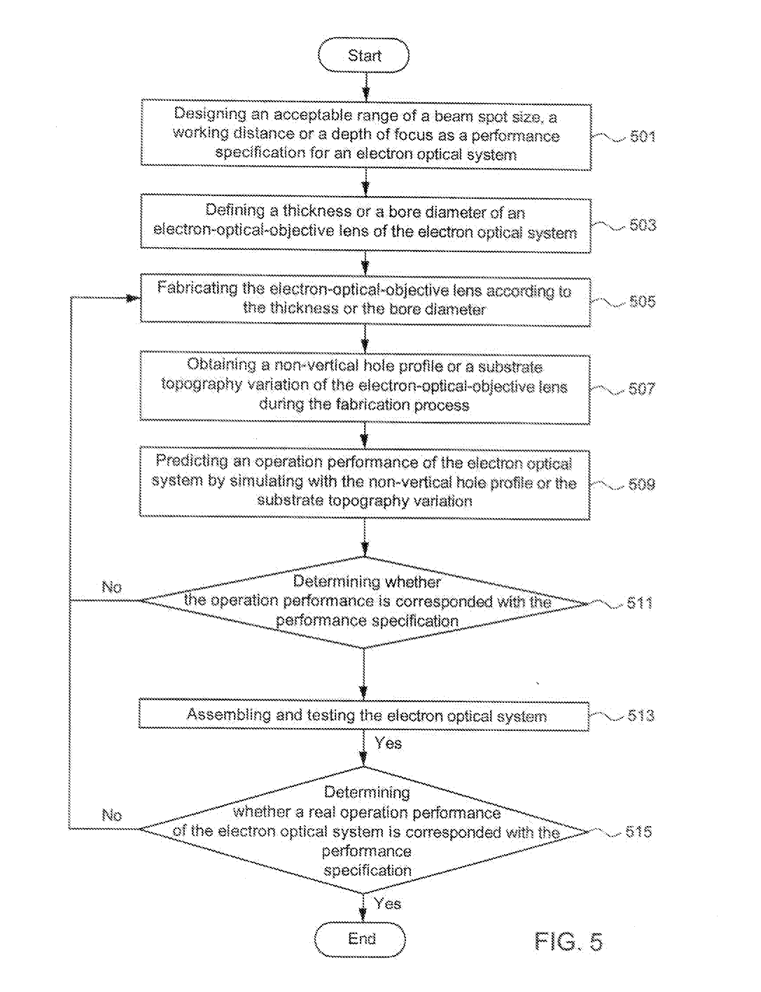

In conjunction with FIG. 1 and FIG. 3, FIG. 5 is a flowchart of exemplary method elements of manufacturing the charged-particle-optical system (CPOS) in accordance with an embodiment of the disclosure.

Charged-particle beam lithography is a promising next-generation form of lithography because of its high resolution and the elimination of masks. Multiple charged-particle-beam-direct-write (MCPBDW) lithography has been proposed and investigated to increase throughput. For example, utilizing micro-electro-mechanical systems (MEMS) processes to fabricate a charged-particle-optical system (CPOS) may cause the dimension of a charged-particle beam lithography system to be shrunk substantially.

Micro-column performance highly depends on the selection and accuracy of CPOS fabrication processes. A widely utilized technique, referred to as the drill-then-bond method, is to first form the holes of an charged-particle-optical-objective-lens (CPOOL) on each of the electro and insulator substrates and then bond the substrates together. The other technique, referred to as the bond-then-drill method, prevents the difficulties of aligning various electrodes. All the electro and insulator substrates are first bonded together and holes are formed through the bonded multilayer structure.

However, in both the drill-then-bond and the bond-then-drill methods, there are issues that need to be addressed. For example, the taper-shaped structures with typical drilling processes may result in differences between the hole diameter at the top of the CPOOL and that at the bottom. In addition, substrate flatness may change after the bonding process.

Referring now to FIG. 5, at step 501, a designer at the design house 11 defines an acceptable range of a beam spot size, a working distance, a depth of focus, or a lithography line width as a performance specification for an CPOS. In one embodiment, the designer inputs the performance specification to the CAD system 31 via the input unit 313. The processing unit 310 may receive the performance specification and store it in the memory unit 315. At step 503, the designer defines a thickness or a bore diameter of an CPOOL of the CPOS as at least one fabrication parameter. In one embodiment, the designer may define the at least one fabrication parameter by simulation techniques or a mathematic operation via the CAD system 31.

After step 503, the designer may operate the CAD system 31 to transmit the fabrication parameters to the manufactory 13. In one embodiment, processing unit 310 may receive the fabrication parameter and output it via the transmitting unit 319. At step 505, the manufactory 13 may fabricate the CPOOL of the CPOS according to the at least one fabrication parameter. After fabrication, there may be at least one fabrication error if a measured value of the fabricated component deviates from at least one fabrication parameter. In one embodiment, the CPOOL may be fabricated by the bound-then-drill method with a wafer bonder machine and an UV-laser drilling machine, where the drill method comprises etching or ultrasonic drilling. The at least one fabrication error, for example a non-vertical hole profile or a substrate topography variation, may result from an imperfect laser energy distribution or etching time. At step 507, a measuring apparatus at the manufactory 13 may measure or sensor the at least one fabrication error that occurred during the fabrication process and output the at least one fabrication error to the design house 11. In one embodiment, the design house 11 may actively require the fabrication error via the CAD system 31 after the CPOOL is fabricated. The CAD system 31 may obtain the at least one fabrication error via the transmitting unit 319.

At step 509, the CAD system 31 may predict the effects of the at least one fabrication error on a focusing performance of the CPOOL as at least one operation performance value of the CPOS by simulating the current fabrication error via the simulation module 317. In one embodiment, the simulation module 317 may employ charged-particle trajectory simulations, such as IES Lorentz 2D/RS for directly tracing the charged-particle through the CPOS. The at least operation performance value may comprise the beam spot size, the working distance, or the depth of focus of the CPOOL. In one embodiment, the simulation results show that the working distances and the depth of focuses all increase with the size of the larger hole diameter of the CPOOL, wherein the expected performance changes are also acceptable. Additionally, the influences of the substrate deflections on the working distances may all be less than 1.5%, wherein the topography variation of the developed bonding process is acceptable. In other words, the operation performances of the CPOS may be acceptable even with significant fabrication errors.

At step 511, the processing unit 310 may determine whether the at least one operation performance value corresponds with the at least one performance specification. If the at least one operation performance value does not correspond with the at least one performance specification, the processing unit 310 may output an indicating signal to the manufactory 13 via the transmitting unit 319. The indicating signal may indicate to the manufactory 13 to repeat fabricating the CPOOL as shown at step 505 by at least one new fabrication parameter. The loop between step 505 and step 511 may be replayed until the processing unit 310 determines the current operation performance corresponds with the performance specification.

If the processing unit 310 determines the current operation performance corresponds with the performance specification, the processing unit 310 may output another indicating signal to the manufactory 13 to assemble and test the CPOS as shown at step 513. In one embodiment, a testing apparatus at the manufactory 13 may obtain a real operation performance of the assembled CPOS such as the beam spot size, the working distance or the depth of focus of the CPOOL. In one embodiment, the testing apparatus may determine whether the real operation performance of the CPOS corresponds with the at least one performance specification. If the real operation performance does not correspond with the at least one performance specification, the manufactory 13 will repeat fabricating the CPOOL of the CPOS (i.e., at step 505) by at least one new fabrication parameter until the current real operation performance value corresponds with the performance specification.

In alternative embodiment, the testing apparatus may transmit the real operation performance to the CAD system 31, and the processing unit 310 may determine whether the real operation performance of the CPOS corresponds with the performance specification. If the real operation performance does not correspond with the performance specification, the processing unit 310 will output another indicating signal to the manufactory 13. Then the manufactory 13 will repeat fabricating the CPOOL of the CPOS (i.e., at step 505) by at least one new fabrication parameter until the real operation performance corresponds with the performance specification.

Accordingly, a new CPOS design-to-manufacturing method that takes fabrication errors into account before the assembly step has been proposed. The manufacturability analysis on the fabricating inaccuracy may provide useful information to improve the design and fabrication. It is expected that this process may significantly improve the fabrication yield of MCPBDW systems since fabrication errors and imperfect components may be effectively screened before the CPOS is assembled.

Realizations in accordance with the present disclosure have been described in the context of particular embodiments. These embodiments are meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope of the disclosure as defined in the claims that follow.

What is claimed is:

1. A method of manufacturing an optical system, the method comprising:
defining at least one performance specification for an optical system;
defining at least one fabrication parameter of a component of the optical system;
fabricating the component according to the at least one fabrication parameter;
obtaining at least one fabrication error of the component during the fabrication process if a measured parameter of the fabricated component deviates from the at least one fabrication parameter;
predicting at least one operation performance value of the optical system by simulating fabrication with the at least one fabrication error;
determining whether the at least one operation performance value corresponds with the at least one performance specification; and
repeating fabricating the component by using at least one new parameter if the at least one operation performance value does not correspond with at least one the performance specification.

2. The method according to claim 1, further comprising assembling and testing the optical system if the at least one operation performance value corresponds with the at least one performance specification.

3. The method according to claim 1, wherein the optical system is a wave optical system or a particle optical system.

4. The method according to claim 1, wherein the optical system is a zone plate array lithography system.

5. The method according to claim 4, wherein the at least one performance specification comprises an acceptable range of a beam spot size or a lithography line width.

6. The method according to claim 4, wherein the component comprises a diffractive-optical element.

7. The method according to claim 6, wherein the at least one fabrication parameter comprises a zone number or a focal distance of the diffractive-optical element.

8. The method according to claim 1, wherein the at least one fabrication error is obtained by measuring during the fabrication process.

9. The method according to claim 1, wherein the at least one fabrication error comprises a zone-width variation or an etching depth variation.

10. The method according to claim 1, wherein the optical system is a charged-particle optical system.

11. The method according to claim 10, wherein the at least one performance specification comprises an acceptable range of a beam spot size, a working distance, a lithography line width, or a depth of focus.

12. The method according to claim 10, wherein the component comprises a charged-particle-optical-objective lens.

13. The method according to claim 11, wherein the at least one fabrication parameter comprises a thickness or a bore diameter of the charged-particle-optical-objective lens.

14. The method according to claim 13, wherein the at least one fabrication error results from an imperfect laser energy distribution, or etching time.

15. The method according to claim 14, wherein the at least one fabrication error comprises a non-vertical hole profile or a substrate topography variation.

16. The method according to claim 1, wherein the at least one fabrication parameter is obtained by simulation according to the at least one performance specification.

17. The method according to claim 1, wherein the at least one fabrication parameter is obtained by a mathematic operation according to the empirical value.

18. A computer-aided design system of manufacturing an optical system, the system comprising:
an input unit configured to receive at least one performance specification and at least one fabrication parameter of a component of the optical system;
a memory unit;
a processing unit connected to the input unit and the memory unit and configured to store the at least one performance specification and the at least one fabrication parameter in the memory unit;
a transmitting unit connected to the processing unit and configured to transmit the at least one fabrication parameter to a manufactory and receive at least one fabrication error of the component during the fabrication process from the manufactory if a measured parameter of the fabricated component deviates from the at least one fabrication parameter; and
a simulation module connected to the processing unit and configured to simulate with the at least one fabrication error to predict an operation performance value of the optical system;
wherein the processing unit is configured to determine whether the operation performance value corresponds with the at least one performance specification, and output an indicating signal to the manufactory via the transmitting unit.

19. The system according to claim 18, wherein the indicating signal is configured to instruct the manufactory to repeat fabricating the component by at least one new fabrication parameter if the operation performance value does not correspond with the at least one performance specification.

20. The system according to claim 18, wherein the indicating signal is configured to instruct the manufactory to assemble and test the optical system if the operation performance value corresponds with the at least one performance specification.
